(19) United States
(12) Patent Application Publication
(10) Pub. No.: US 2006/0221776 A1
(43) Pub. Date: Oct. 5, 2006

(54) DOCKING APPARATUS AND MIXER FOR PORTABLE MEDIA DEVICES

(75) Inventors: Christopher Roman, Wrentham, MA (US); Brian Shim, Santa Monica, CA (US)

Correspondence Address: BARLOW, JOSEPHS & HOLMES, LTD., 101 DYER STREET, 5TH FLOOR, PROVIDENCE, RI, 02903, US

(73) Assignee: Numark Industries, LLC, Cumberland, RI (US)

(21) Appl. No.: 11/277,810

(22) Filed: Mar. 29, 2006

Related U.S. Application Data
(60) Provisional application No. 60/667,542, filed on Apr. 1, 2005.

(51) Int. Cl. H04B 1/20

(52) U.S. Cl. 369/1

(57) ABSTRACT

A docking system and mixer for portable media devices includes two control interfaces that correspond to two dock seat to receive two media storage devices, such as a portable music player, therein. A microcontroller resides in the housing and the media controls on the housing for each of the players are electrically interconnected to the microcontroller. Media items are stored on storage components, such as a hard drive, in each of the portable media devices. Manipulation of the control surfaces commands the operation of the media storage devices, such as playback of an audio or video file thereon. The outputs of both of the media storage devices are controlled and mixed via a disc jockey style interface.

### CROSS REFERENCE TO RELATED APPLICATION

This application is related to and claims priority from earlier filed provisional patent application Ser. No. 60/667,542, filed Apr. 1, 2005.

### BACKGROUND OF THE INVENTION

The invention relates generally to equipment for playback and control of multimedia. More specifically, the present invention relates to disc jockey mixing equipment for control of the playback of multimedia files, such as audio and video files.

In the music industry, there is a need for a person, such as a disc jockey, to be able to playback multimedia with control and precision. Such multimedia is available in many different forms.

For example, it has been well known for many years that audio is available on analog vinyl discs. In particular, music recordings have been available on vinyl records and have been widely played by disc jockeys on turntables during a playback performance. However, there is typically a need and desire to provide continuous music playback during a disc jockey performance. To carry this out, two or more turntables have been commonly employed whereby one turntable plays the current selection of music while the second turntable is used to cue up the next selection. When the first selection of music is nearing its end point or is at its end point, playback to the second turntable can be switched to the second turntable without interruption of the master output. It is also very well known that the transition from one turntable to another can be mixed or faded back and forth for seamless transition from one music selection to another. This back and forth transition and mixing can be carried out back and forth indefinitely during a disc jockey performance.

To carry out this mixing, a disc jockey mixing device is typically employed. The mixer commonly includes two inputs, one for each music source, such as a turntable, and a master output. A control interface is provided on the mixer so that the disc jockey can intuitively control the mixing and output of the media sources. This interface is critical so that the disc jockey can effectively control such mixing and playback output of the media for an engaging performance.

When turntables and vinyl records are used as the source for audio as the media, the cueing and playback of the audio are dictated by the turntable itself. The disc jockey must physically place the vinyl record on the turntable, place the needle on the desired spot and cue it up for playback when desired. When it is time for that selection to be outputted for playback, the mixer is manipulated to switch or fade to that selection so that it can be heard at the master output. When the selection is no longer desired, the turntable is the stopped by actuating the appropriate button or control on the turntable itself.

In general, the controls on the turntable itself are used to control playback and command operation of the turntable. As a result, disc jockey turntables provided with controls that are particularly well-suited for fast and easy control of a vinyl record. For example, play and cue buttons are typically very large and easily accessible, which is essential in a dark night club and where selection changes are frequent.

Vinyl records played back by turntables are a well known source of media for playback by a disc jockey, recently, there have been many new forms of digital media that are suitable for use by a disc jockey. For example, digital compact discs (CDs) are now a common storage format for media, such as digital audio. The digital audio is stored on an optical CD. Turntables are commonly substituted by compact disc players and mixed, as described above. Control of transport and operation of a CD and the audio files thereon can be carried out easily by providing disc jockey friendly operation controls thereon. For example, the playback/cue button can be large and intuitively placed on the CD player to facilitate the disc jockey performance.

In similar fashion to CDs, which store digital files on a optical disc, other storage media have been employed to store digital audio file for easy playback. For example, digital audio files can be stored on hard disks and memory RAM cards. These storage devices can also serve as the source of media files for later playback and mixing by a disc jockey. These storage devices can be separate units that serve as input sources for a disc jockey mixer, as an alternative media source for an analog turntable or CD player. For example, media players with hard disks and/or memory card slots for receipt of removable media are well known in the art. As with turntables and CD players, these are units that are provided with large and intuitive controls for playback and command of the media files. These controls are commonly specifically laid out and arranged for disc jockeys to facilitate their disc jockey performance.

It is also known in the art that CD players, hard disk players can be integrated with a disc jockey mixer for a single device solution. However, these units are still large enough and configured by design for use by disc jockeys.

Recently, portable media devices have become very popular for their compact size, large storage capacity and dropping cost. Portable media devices are available in the form of portable hard disk drives and, in particular, portable media players. These portable media players can playback audio files in many different formats, such as “mp3” and “wmv”. Also, many of these players can playback video files in different formats, such as “avi” and “divx”. For example, portable media players manufactured by Creative Technology Ltd., Apple Computer, Inc. and Archos, Inc. are widely sold with this capability.

These players typically include their own operating system and transport and command controls on the devices themselves so the user can playback and control files when desired. These portable devices are, essentially, personal players in that they are typically meant to be held in the hand or hands of the user so that the user can manipulate the controls for playback through headphones or a stereo system, for example.

While these transport and command controls are suitable for most uses of the portable players, there is often a need to enhance or improve the control of the personal player for other uses. For example, remote controls have been provided for portable media players. A receiver is connected to the portable player that is interconnected with the operating system of the player. A wireless remote that uses infrared, for example, includes a duplication of some or all of the transport and command controls of the actual device. Pressing a button on the remote transmits commands to the receiver to thereby control operation of the portable player. Such a wireless remote is well suited for operating a portable player from a distance without having to touch the player itself.

Many portable devices include their transport and command controls on the front face of the player. If the player is in a case without only its top edge exposed, the entire player must be removed so that the controls can be manipulated. To address this problem, there are prior art control modules that can be plugged into the edge of a players, such through it headphone jack which commonly includes additional contacts for access to the players operating system.

Alternatively, some of the transport and command controls can be duplicated on a tethered connection to the player, such as inline with the headphones. Due to the small size that is feasible on a small tethered control, only the primary transport and command controls are provided thereon.

In the prior art, it has also been known to provide a dock for receipt of the portable player therein where some of the controls are repeated on the dock to facilitate use. For example, many stand alone powered speaker units that include a dock for a portable media player have such duplicated controls for use to obviate the user to manipulate the controls on the player itself.

While the controls on a portable players are sufficient for a person to manipulate while in their hand, these controls are not well suited for use by a disc jockey during a performance. Moreover, duplicated transport and command controls for a portable media player, such as those on tethered remotes, plug-in modules and powered speakers are inadequate for use by disc jockeys. They are not laid out in an intuitive or logical fashion for use by a disc jockey. Moreover, none of them provide mixing capabilities between more than one portable player. Also, none of them can stream and mix audio from the same or two different portable media players. Further, none of the prior devices provide a way to mount the portable media player so its screen can be easily viewed in connection with its respective player controls. The prior art is also devoid of a device that has two separate dedicated sets of disc jockey style controls for each portable players.

In view of the foregoing, there is a demand for a docking apparatus that can receive portable media devices, such as portable media players. There is a demand for a docking apparatus for portable media devices that includes controls for command of operation of devices docked into the docking apparatus. There is another demand for a docking apparatus for portable media players that can mix media streamed from two portable media devices docked therein. There is a demand for a docking apparatus for portable media players that duplicates the controls of a portable media player in a disc jockey style layout. There is yet another demand for a docking apparatus for portable media players that dock portable media players for display of media information thereon. There is a demand for a docking apparatus for portable media players that can adjust the volume and modify the sound profile of media being played back from the portable media players.

### SUMMARY OF THE INVENTION

The present invention preserves the advantages of prior art mixers and docking systems for portable media storage devices and portable media players. In addition, it provides new advantages not found in currently available devices and overcomes many disadvantages of such currently available—devices.

The invention is generally directed to the novel and unique docking system and mixer for portable media storage device and portable media players.

The present invention includes a new and unique docking apparatus that provides control interfaces for a first portable media storage device and a second portable media storage device. The devices can be, for example, a portable media player with audio and/or video files thereon.

The apparatus includes a housing having first media controls and second media controls thereon. A microcontroller resides in the housing and handles processing of media files.

The first media controls and the second media controls are electrically interconnected to the microcontroller. The first and second portable media storage devices each have a first media storage component therein with at least one media item thereon. The first and second media storage components are electrically interconnected to the microcontroller, such as by a dock interconnection. Manipulation of the first media controls and second media controls on the housing respectively commands operation of media items on the first media storage component and the at least one media item on the second media storage component. Outputs connected to the portable media storage devices can be mixed and fully controlled in a disc jockey fashion where the first media controls and the second media controls on the housing respectively duplicate the functionality of controls on the first portable media player and the second portable media player or control the playback and transport of media files respectively thereon. The master volume of the mixed outputs of the first portable media device and the second portable media device can be controlled by a control on the housing.

It is therefore an object of the present invention to provide a docking apparatus for portable media devices.

It is another object of the present invention to provide a docking apparatus that can receive portable media devices, such as portable media players.

It is another object of the present invention to provide a docking apparatus for portable media devices that includes controls for command of operation of devices docked into the docking apparatus.

It is yet a further object of the present invention to provide a docking apparatus for portable media players that can mix media streamed from two portable media devices docked therein.

It is another object of the present invention to provide a docking apparatus for portable media players that duplicates the controls of a portable media player in a disc jockey style layout.

It is an object of the present invention to provide a docking apparatus for portable media players that dock portable media players for display of media information thereon.

It is another object of the present invention to provide a docking apparatus for portable media players that can adjust the volume and modify the sound profile of media being played back from the portable media players.

### BRIEF DESCRIPTION OF THE DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a perspective view of the docking apparatus for portable media devices of the present invention;

FIG. 2 is a front view of the docking apparatus of FIG. 1;

FIG. 3 is a rear view of the docking apparatus of FIG. 1;

FIG. 4 is a top view of the docking apparatus of FIG. 1;

FIG. 5 is a bottom view of the docking apparatus of FIG. 1;

FIG. 6 is a close-up front perspective view of the docking seat in accordance with the present invention;

FIG. 7 is a front view of a portable media device that can be docked in and commanded by the docking apparatus of the present invention;

FIG. 8 is a bottom perspective view of the portable media device of FIG. 7;

FIG. 9A is a top view of the bottom circuit board employed in the docking apparatus of the present invention;

FIG. 9B is a bottom view of the bottom circuit board employed in the docking apparatus of the present invention;

FIG. 10 is a bottom view of the top circuit board employed in the docking apparatus of the present invention; and

FIG. 11 is a close-up view of an encoder used to track a control wheel in accordance with the present invention;

FIG. 12 is a block diagram showing operation of the present invention commanding operation of one media storage device with one output;

FIG. 13 is a block diagram showing operation of the present invention commanding operation of one media storage device with two outputs;

FIG. 14 is a block diagram showing operation of the present invention commanding operation of two media storage devices with two outputs; and

FIG. 15 is a block diagram showing operation of the present invention commanding operation of one media storage devices with at least one digital output stream.

### DETAILED DESCRIPTION OF THE PREFERRED EMBODIMENT

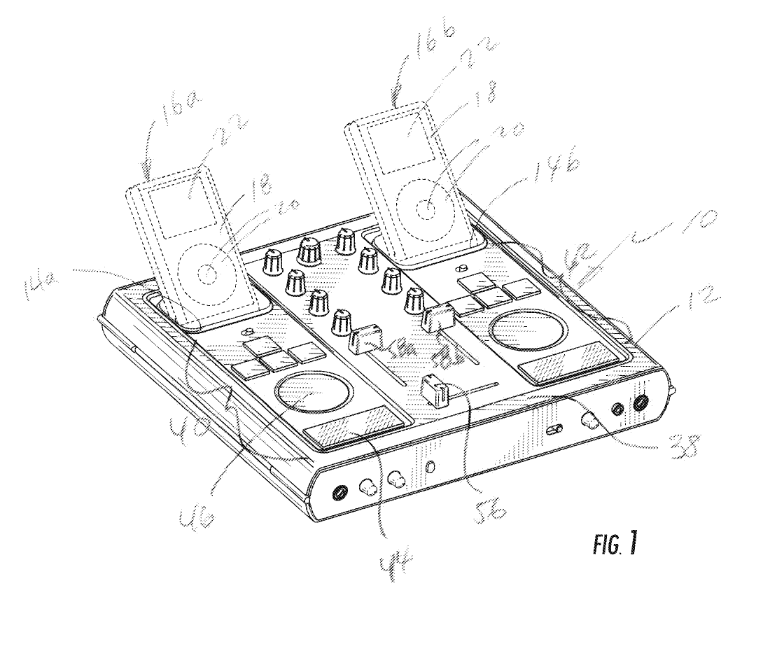

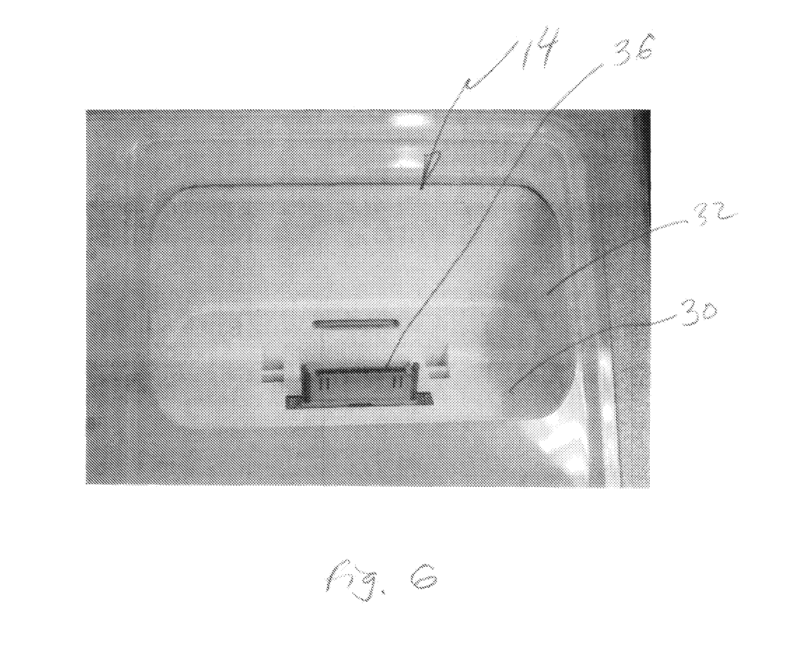

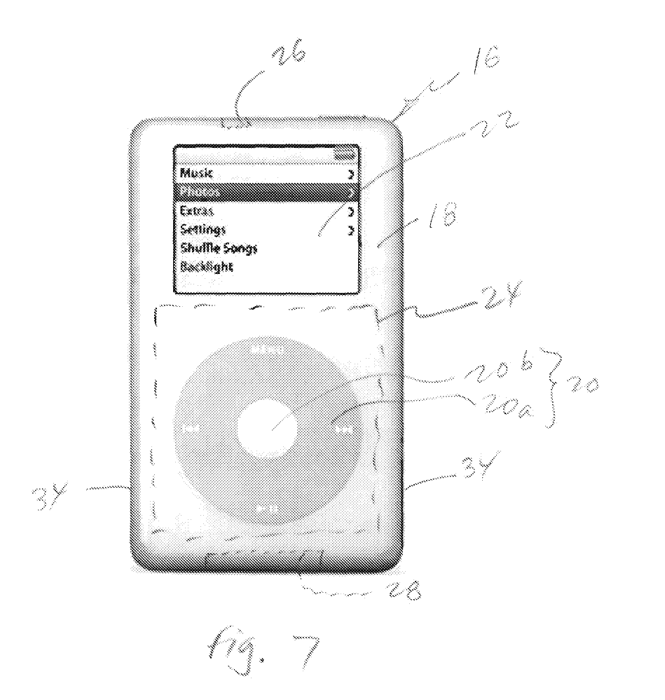

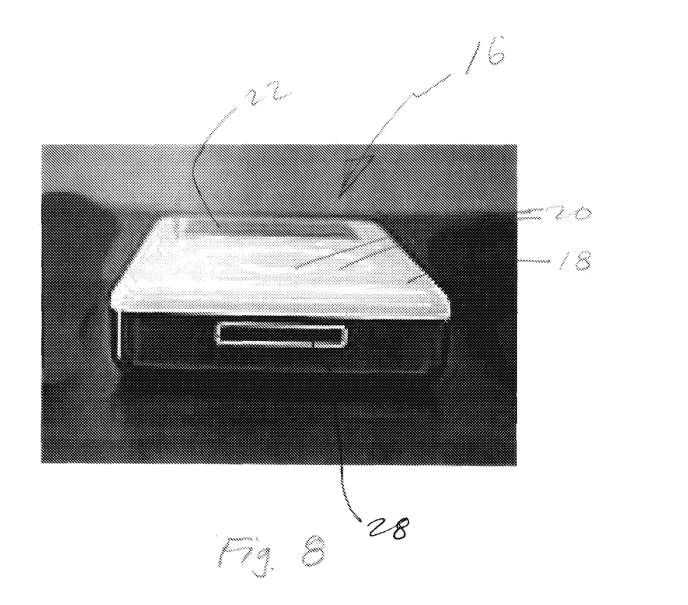

Turning first to FIG. 1, a perspective view of the docking apparatus 10 of the present invention is shown. The docking apparatus 10 includes a main housing 12 with a pair of seats 14a, 14b, generally referred to as 14, to respectively receive two portable media devices 16a, 16b, generally referred to as 16, therein. FIG. 6 illustrates a close-up view of one of the seats 14 that can receive a portable media device 16, such as a portable media player, an example of which is shown in FIGS. 7 and 8. The seats 14a, 14b may be reconfigurable to accommodate portable media devices 16 of different sizes and configurations. For example, different seat inserts (not shown) can be provided for this purpose.

As seen in FIGS. 7 and 8, a common portable media device 16 is a portable media player that has an player housing 18 with control buttons 20 thereon and a display 22 screen. Disposed within the player is a storage component 24, such as a computer hard disk. The storage component 24 may also be solid state memory or a removable memory or storage card. Media items, such as audio files and/or video files are stored on the storage component 24. A headphone connector 16 is also provided on the portable media device 16.

An operating system exists on the portable media device 16 that controls and commands operation of the device. Details of the operation of a portable media device 16 are so well known in the art, they need not be discussed in detail herein. By way of background, a media file, such as an audio file, may reside on a hard drive 24 within the player housing 18. Using the controls 20 on the front the device 16 with the assistance of the display screen 22, the user can navigate to the desired media file, select it and then play it back. For audio, the sound can be played back via an audio output jack, such as the headphone connector 26 as in FIG. 7 or via the bottom connector port 28 shown in FIG. 7 and FIG. 8. The bottom connector port 28 enables connection to external device hardware, such as via a specialized connector cable (not shown) to a computer or directly to powered speaker arrangement.

The seats 14a, 14b provide a docking location for the portable media device 16 shown in FIGS. 7 and 8. As can be seen in FIG. 6, each seat 14 preferably includes a floor 30 and side walls 32 to support the outer walls 34 of the portable media device 16. An interface connector 36 is provided on the floor 30 of the seat 14 to electrically interconnect with the portable media player 16 itself, namely, via its bottom port, as can be seen in detail in FIG. 8.

Referring back to FIG. 1, a pair of portable media devices 16a and 16b are shown docked into their respective seats 14a, 14b with the bottom connectors 36 electrically interconnected to respectively connected to bottom ports 28. As will be described below, it is possible that only one portable media device 16 is installed in one of the seats 14a, 14b in accordance with the present invention. The walls 30, 32 of the seats 14a, 14b are preferably configured so that a portable media device 16 is positioned at an angle relative to the top surface 38 of the main housing 12 so that their display screens 22 can be viewed easily by a user operating the apparatus of the present invention. This angle can be modified during manufacture, as desired.

Further, the seat 14 shown in FIG. 6 is shown to accommodate a portable media device 16 of the type substantially shown in FIGS. 7 and 8. It is also possible that the seat floor 30 and walls 32 can be modified or substituted with a floor and walls of other configurations to accommodate portable media devices of different sizes and configurations. Still further, the connector 36 can be modified as well to accommodate the portable media device 16 at hand.

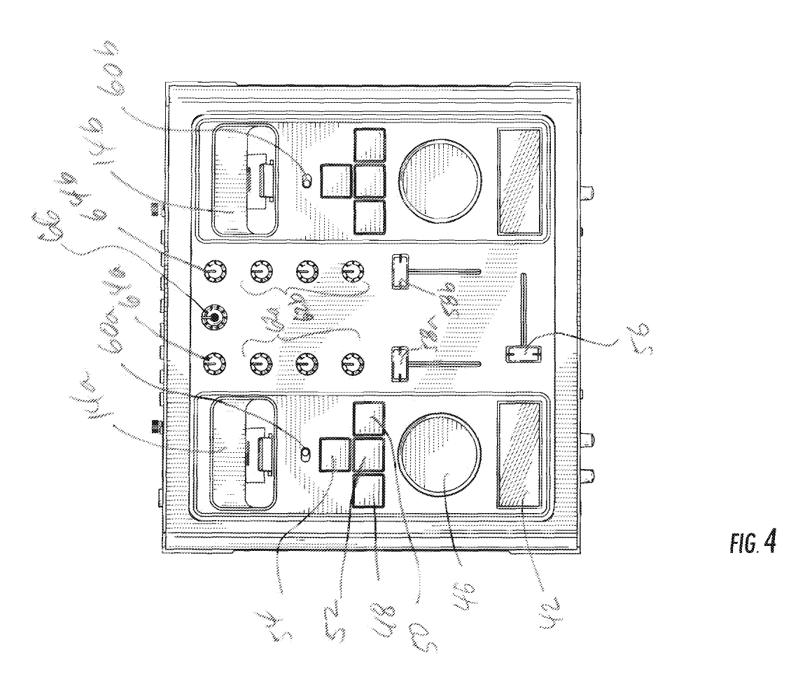

A primary unique aspect of the present invention is to provide an apparatus 10 with array of disc jockey friendly controls for each portable media device 16 to control the operation thereof. In FIGS. 1 and 4, a top view of the apparatus 10 of FIG. 1, details of the preferred layout of the controls of the present invention are shown in detail. In general, two sets of controls, one set 40 for Channel 1 and another set 42 for Channel 2, are provided which are, preferably identical in layout and operation. Both of which are positioned directly adjacent, e.g. below, their respective seats 14a and 14b to receive a portable media device 16a and 16b therein.

Each array 40, 42 includes controls that preferably duplicate functionality that can be carried out by the controls on the player 16 itself. As can be understood, the controls on the player device 16 are very small and difficult to operate with precision by a disc jockey during a performance. The controls 40, 42 on the top surface of the main housing are ergonomically laid out and configured specifically for operation by a disc jockey.

Both sets of controls 40 and 42 are same. For ease of discussion, description of controls 40 are described. A PLAY/PAUSE button 44 is provide that plays and pauses media being played from the portable media device 16. A control wheel 46 duplicates the functionality of the control wheel 20a found on the portable media device 16 itself. For example, track selection can carried out with the assistance of the control wheel 46. A previous track button 48 selects the previous track on the portable media device 16. A next track button 50 selects the next track on the portable media device 16. An ENTER button 52 duplicates the functionality of the “Enter” button 20b found on the portable media device 16. For example a track can be selected for playback by pressing the ENTER button 52. A MENU button 54 is provided which duplicates the operation of the “Menu” button on the portable media device 16. For example, the previous menu can be selected by pressing the MENU button 54.

As stated above, two array of controls 40, 42 are provided to respectively control and command the media output of, for example, a pair of portable media devices 16a, 16b. Each of the devices 16a, 16b have an output which can be either via the headphone jack 26 or via the docking connector 28. The docking apparatus 10 of the present invention uniquely provides mixing of the output of the portable media devices 16a, 16b via their docking connectors 28. It is well known that audio and/or video signal outputted through the connector port 28 on the bottom of the portable media player 16. It is through this port 28 that the docking connectors 36 receive these signals for mixing and control in accordance with the present invention. Details of the specification of the bottom port 28 and which pins thereof carry audio, video, power and the like are well known in the art and need not be discussed in detail herein. It is generally understood that audio and/or video signal pass are outputted via the bottom connector port 28.

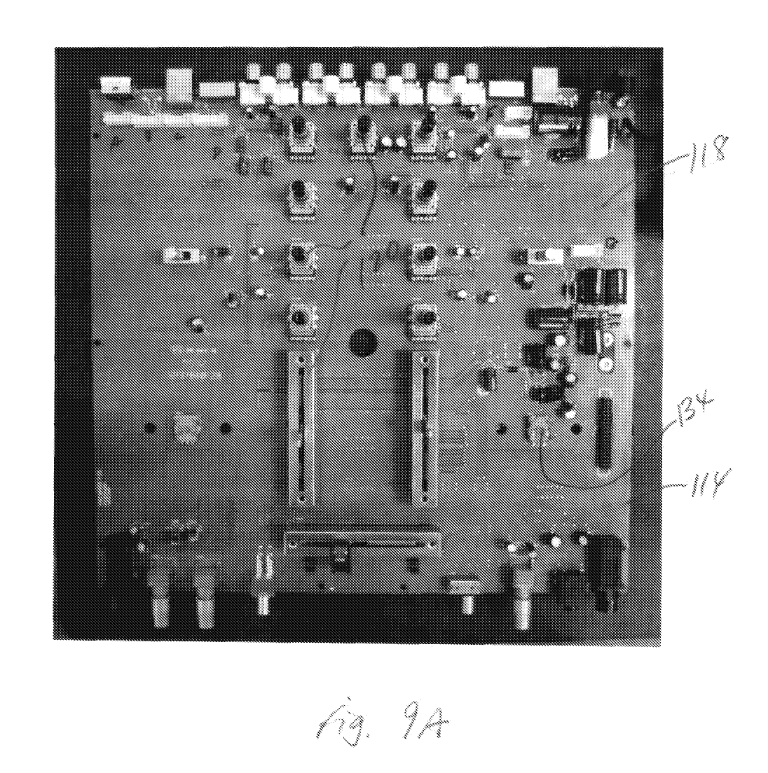

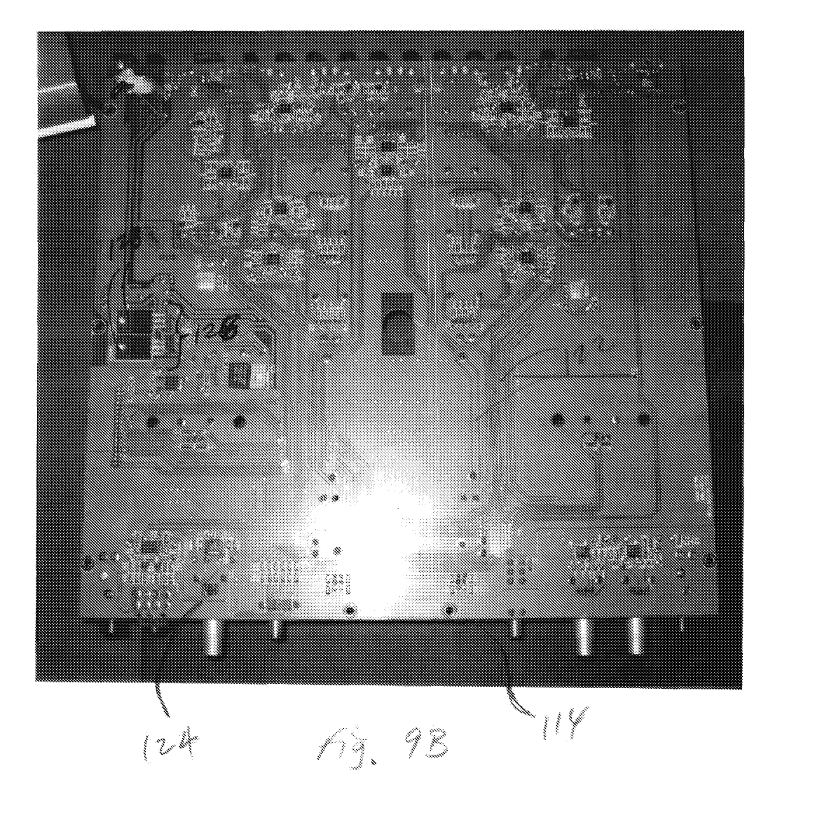

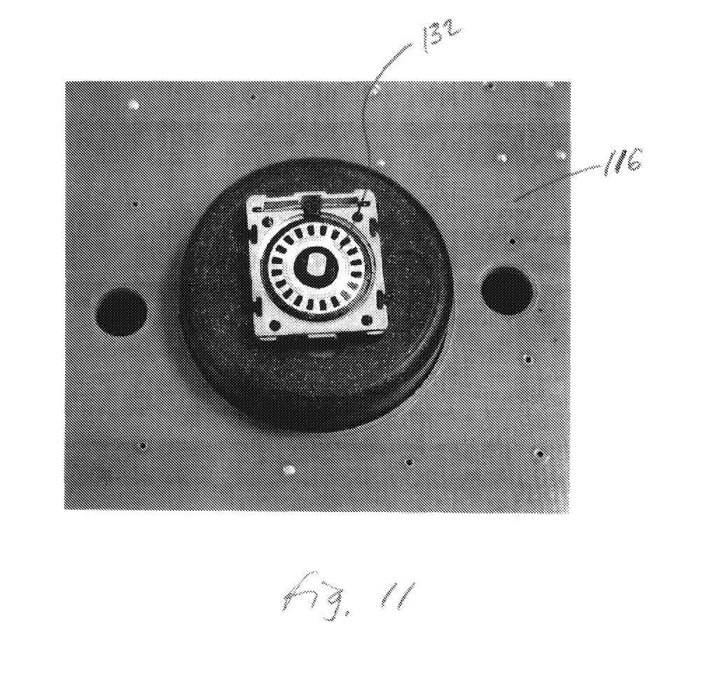

The interface connectors 36 on the bottom of the seats 14a, 14b enable the audio and/or video signals to be routed directly to the apparatus 10 of the present invention for mixing and other control. Details of the inner components of the apparatus 10 of the present invention will be discussed below in connection with FIGS. 9-11.

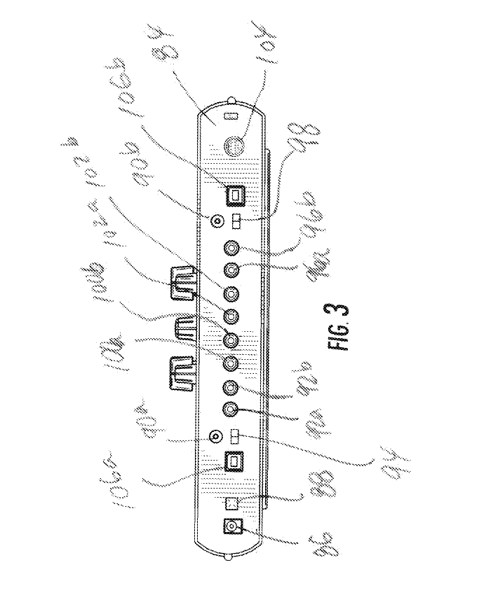

First, by way of background, the signal mixing and control capabilities are shown in connection with FIGS. 1-5. A crossfader 56 is used to mix between the two output signals emanating from the two portable media devices 16a, 16b. Line faders 58a, 58b are provided to adjust the signal level of a device 16a and 16b, such as the audio signal level, for a given channel. Generally Channel 1 corresponds to the media output from the device 16a on the left and the Channel 2 corresponds to the media output from the device 16b on the right. An input selector 60a, 60b controls which signal is inputted into a given channel. Preferably, the signal emanating from the portable media players 16a, 16b on each side are being routed into the mixer. However, the apparatus 10 may be used as a standard disc jockey mixer where any signal output may be routed into the mixing subsystem. A preferably two-position input selector 60a, 60b is provided for each channel or side of the apparatus 10 where one position selects the source signal from the portable media player 16 to be supplied to the mixer while a second position selects an alternative line in or phono position as the port for supply of signal. Details of these interconnections will be discussed in connection with FIG. 3 below.

Still further a three band equalizer 62a, 62b for each channel is provided so the user can custom adjust the sound quality of the signal being mixed and outputted. Each channel has a three band equalizer 62a, 62b to adjust treble, midrange and bass levels of the audio. Gain adjustment 64a, 64b is also provided for each channel which is used to equalize the input levels between the two sources. This is particularly useful when different audio files on different devices 16a, 16b were recorded at different levels which result in varying output levels. Further, a master output control 66 is provided to control the master volume of the apparatus 10 of the present invention which represent the playback performance. The output connectors representing such master output is discussed and shown in connection with FIG. 3 below.

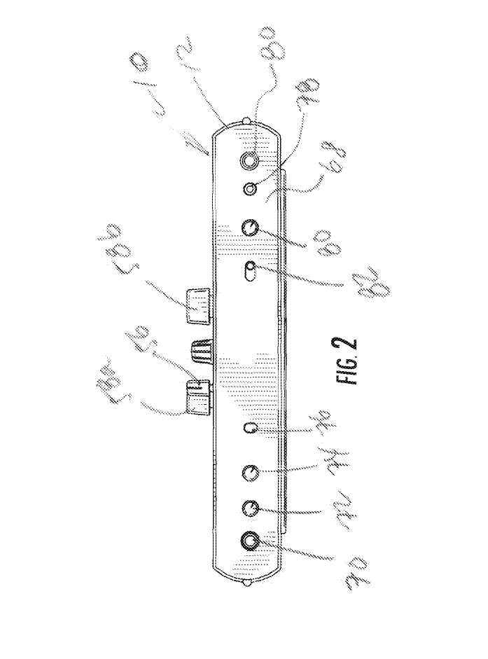

Turning now to FIG. 2, details of interconnections to the apparatus 10 of the present invention via the front control panel is shown. First, a microphone input 70 is provided where the user may connect a microphone for incorporation into the mix for output. Preferably, a female ¼ inch mono jack is provided for this purpose but other interconnections may be used. Next to the microphone input jack 70 is a microphone gain control knob 72 that controls the level of the microphone into the mixer. Also, a microphone tone knob 74 is provided which controls the tone of the microphone input signal. This is employed to improve sound quality and eliminate feedback. In general, the microphone input jack 70, microphone gain knob 72 and microphone tone knob 74 enable the user to incorporate their own voice and other ambient sounds into the mix via a microphone (not shown) connected to the input jack 70.

A unique fader start switch 76 is also provided on the front face68 of the apparatus 10 of the present invention. If desired the movement of the crossfader 56 can be employed to activate the PLAY/PAUSE function of the apparatus 10 (which can be also activated by the PLAY/PAUSE button). Such movement is activated when the fader start switch 76 is in the ON position. Movement of the crossfader 56 will not activate a PLAY/PAUSE command when the fader start switch 76 is in the OFF position.

A ⅛ inch mini stereo headphone connector 78 and ¼ inch headphone connector 80 are provided so that the user can listen to the desired output of the apparatus 10. These two different types of headphone connectors 78, 80 gives the user flexibility of interconnectivity of headphones (not shown). The volume of the output to the headphone connectors 78, 80 is controlled by a cue gain knob 80. Also, the output to headphones is controlled by a CUE/MIX switch 82 which is also provided on the front face 68 of the apparatus. The CUE/MIX switch 82 is preferably a three-way switch where Channel 1 only (in the leftmost position), mixed Channel 1 and 2 together (middle position) or Channel 2 only (in the rightmost position) can be selected.

Referring now to FIG. 3, details of the rear panel 84 of the present invention can be seen. An AC in power supply connector 86 is provided to receive a power source (not shown). A 9 volt, 2.8 amp power source is preferred but other power supplies can be employed if the apparatus 10 is modified accordingly. Next to the power connector is a ON/OFF power button 88 to turn the apparatus 10 on and off. Grounding connectors 90a, 90b are provided to connect the apparatus 10 to a path to ground, to, for example, eliminate humming or avoid shock.

The apparatus 10 of the present invention provides a full array of input and output connectors for audio and video signals routed therethrough. A pair of RCA connectors 92a, 92b, for left and right stereo channels for connecting an external sound source to Channel 1 of the apparatus. An input selector switch 94 is provided to select between either line level input or phono input to Channel 1 via the RCA connectors 92a, 92b for Channel 1. Similarly, a pair of RCA connectors 96a, 96b, for left and right stereo channels for connecting an external sound source to the Channel 2 of the apparatus. An input selector switch 98 is provided for to select between either line level input or phono input to Channel 2 via the RCA connectors for Channel 2.

A pair of RCA connectors 100a, 100b are provided for stereo output of the master stereo output which is the output of the apparatus 10 that is controlled by the Master Gain knob 66 on the top panel of the apparatus 10. These connectors 100a, 100b are ideally used for connection of powered speakers and stereo system thereto. Another pair of RCA connectors 102a, 102b are provided for stereo output of line level. These connectors 100a, 100b are ideally used for connection of recording devices, such as CD burners, tape recorders or the line in of a sound card for a computer.

It is possible that the media item is a video file that is being played back and mixed using the apparatus of the present invention. A video output connector 104, such as an S-video connector is provided for output of video from the apparatus 10 to a video display, such as a computer monitor or projector (not shown).

Computer interface connectors 106a, 106b for both Channel 1 and Channel 2 are provided where a computer can be interfaced with the apparatus 100 for viewing, managing and organizing files directly on portable media devices 16a, 16b installed in the seats 14a, 14b of FIG. 6. For example, if the portable media device 16 is a portable media player with a hard drive therein, a USB connection is preferably provided so that a computer connected thereto with a suitable USB cable, can directly view media files and the file structure thereon. A USB 2.0 connection is preferred for this interconnection.

It should be understood that the various connectors, knobs, buttons and sliders are indicated. However, these are preferred configurations and other configurations are contemplated by the present invention. For example, USB connections are preferred but it is possible to employ IEEE-1394 (also known as Firewire or iLink) connections. Similarly, RCA connectors are preferred, however, optical connections, for example, may be used. While sliders are preferred for fading, such operation can be carried out by knobs.

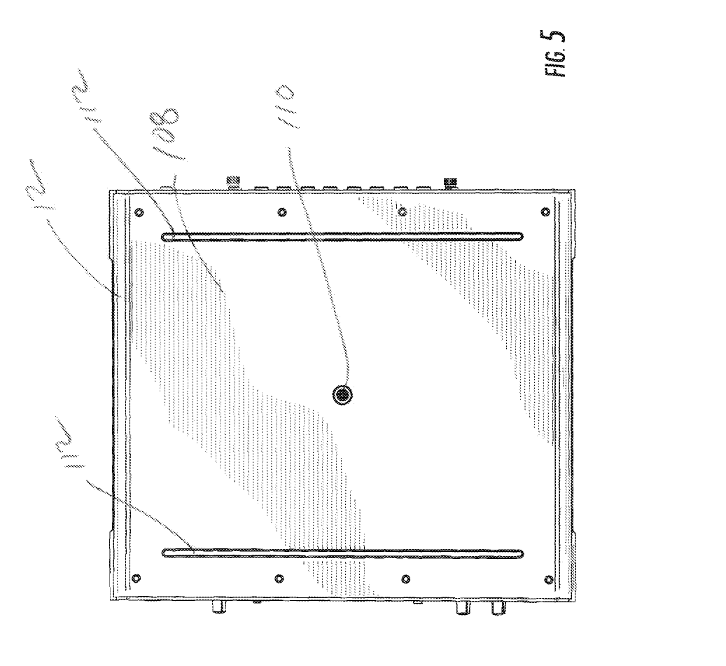

As can be seen in FIG. 5, the bottom panel 108 of the main housing of the apparatus includes a hole 110 that is positioned substantially in the middle thereof with a number of rubber feet 112. As a result, the user can place the apparatus 10 directly on top of a turntable (not shown) where the spindle (not shown) of the turntable is located within the hole 110. As a result, the rubber feet 112 can rest on the top of the turntable with the apparatus 10 being centered on the turntable. This is particularly useful where there is limited table space for the apparatus 10 of the present invention at a performance location.

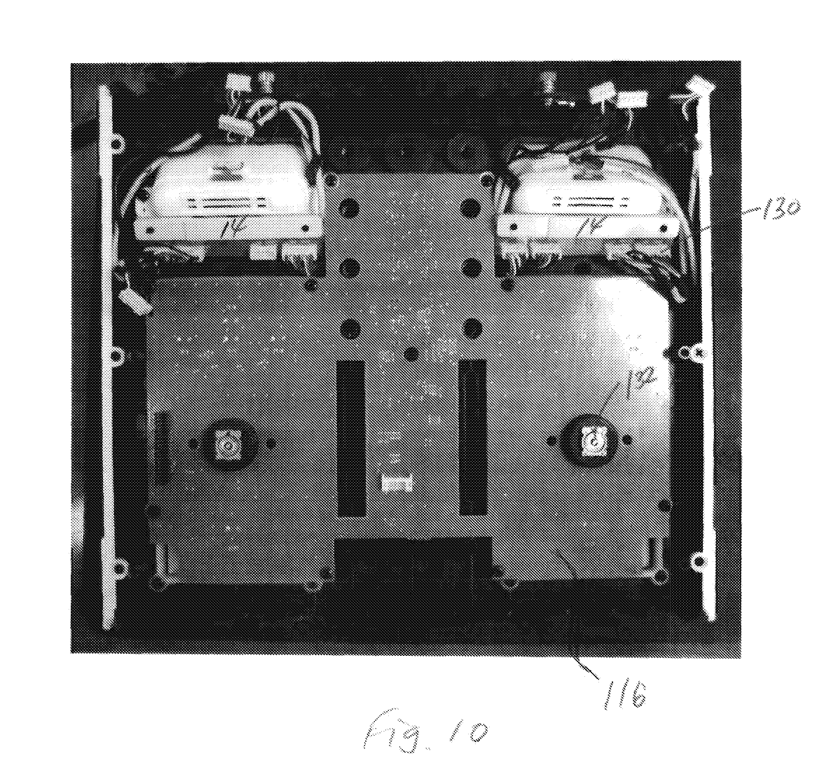

Referring now to FIGS. 9-11, details of the interior components within the apparatus is shown. A lower circuit board 114 is, shown in FIGS. 9A and 9B and an upper circuit board 116, shown in FIG. 10 are contained with the main housing 12 of the present invention. Referring to FIG. 9A, a top surface 118 of the lower circuit board 114 is shown to include a number of mechanical control knobs, sliders and buttons, generally referred to as 120, that correspond with the knobs and slider caps, button and switches seen in FIGS. 1-5.

In FIG. 9B the various circuit board traces 122 can be seen for interconnection of the various control knobs, sliders and buttons employed on the bottom surface 124 of the bottom circuit board 114. Most importantly, a microcontroller 126 is provided on the bottom circuit board 114 for controlling and processing the various signals being routed through the apparatus 10. In this preferred embodiment, a number of integrated circuit chips 128 provide the microcontroller 126 for the apparatus 10. This configuration is one of many different configurations that can be used to carry out the present invention. For example, more or less integrated circuit chips 128 may be used and still be within the scope of the present invention.

Details of microcontrollers 124 and integrated circuit chips 128 are well known in the art and need not be discussed in detail below. The microcontroller 126 is programmed to, for example, ensure that manipulation of the control wheel 46 communicates with the corresponding portable media device 16 to send the appropriate signals thereto that are indicative of control wheel movement. In general, the microcontroller 126 of the apparatus 10 controls the overall operation of the apparatus 10 so that all of the controls, sliders, switches and knobs 120 act as described on the portable media device 16 and the media signal outputted from the apparatus 10.

In FIG. 10, a bottom view of the top circuit board 116 employed in the present invention is shown. As can be seen, the bottom of the seats 14 are shown with electrical connections 130 from the respective interface connectors 36 to the circuit board 116. Referring to FIGS. 9A, 10 and 11, a pair of encoders (132 and 134) are provided respectively for each of the control wheels 46. Referring to one encoder, by way of example, a top encoder disk 132 is provided on the bottom of the top circuit board 116 that is connected to the control wheel 46 itself. When the control wheel 46 turns, so does the encoder disk 132. A sensor 134 is provided on the top surface 118 of the bottom circuit board 114. Thus, when the control wheel 46 rotates, rotation of the encoder disk 132, including speed and direction, is detected by the sensor 134 and relayed to the microcontroller 126 for instruction on to the portable media device 16, namely, a portable media player. As a result, the control wheel 46 can take control of the portable media player 16 and control and command files thereon by using the operating system located on the portable media player 16 itself.

The foregoing encoder 132, 134 is just one example of how movement of control wheel 46 on the apparatus 10 can be relayed on to the portable media player 16 via the microcontroller 126. Other types of sensors 134 attached to the control wheel 46 on the apparatus 10 can be used to detect and report movement of control wheel 46.

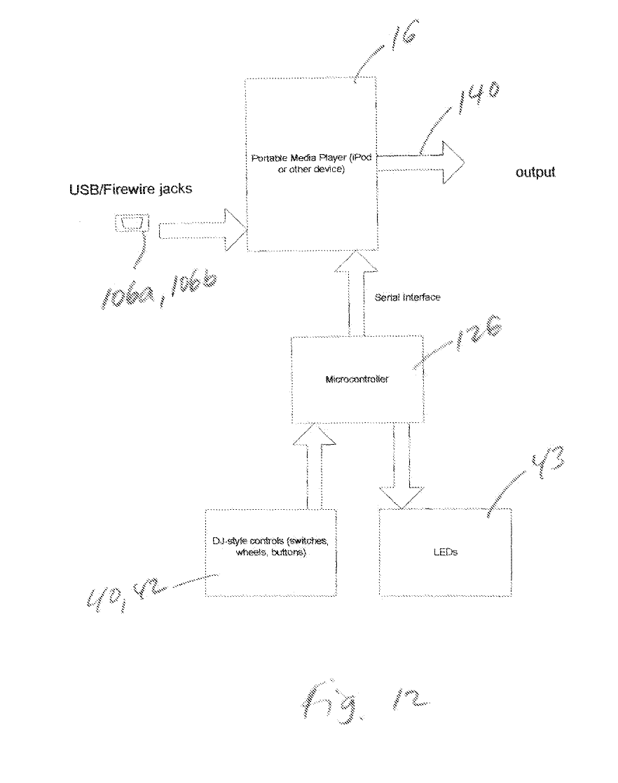

Referring now to FIGS. 12-15, a number of flow charts illustrate various embodiments of the present invention. In FIG. 12, a flow chart of the interconnection of a single portable media device 16, such as a portable media player, to the apparatus 10 is shown. The disc jockey style controls 40, 42, via a microcontroller 126, operate and command a portable media player 16 connected to the apparatus 10. Various displays, including LEDs 43, such as lights to indicate when a given button of control 40, 42 is actuated, to provide visual feedback during operation. Computer connectivity is provided by USB and/or IEEE-1394 connections. The resulting output 140 is an audio and/or video output that is mixed and modified as desired.

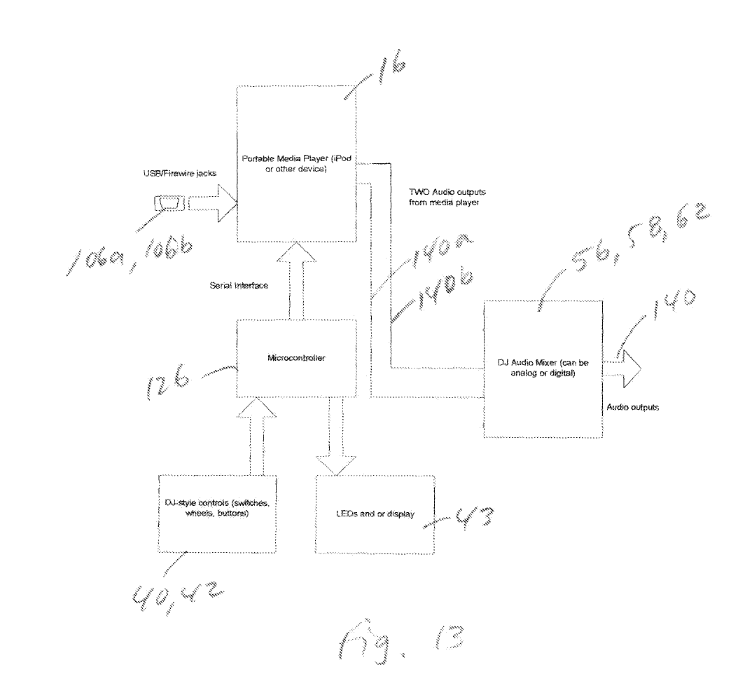

In FIG. 13, an embodiment is shown where a single portable media player 16 is connected to the apparatus 10 can play two simultaneous audio streams from the same player 16. In this case, two media files on the portable media player 16 are accessed simultaneously to provide two outputs 140a, 140b that can be assigned to a Channel 1 and Channel 2 respectively for mixing and output to 140 as described above. The output 140 can be digital or analog.

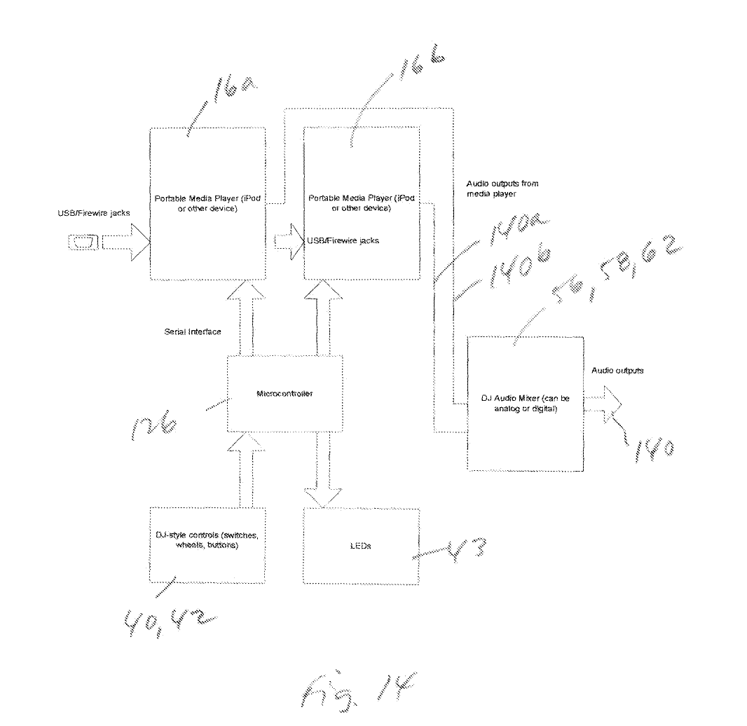

Still further, FIG. 14 shows the interconnection of two different portable media players 16a, 16b respectively to the connectors 36 in the seats 14a, 14b. The disc jockey style controls 40, 42 for Channel 1 and Channel 2 control the respective portable media players 16a, 16b connected to the appropriate channel. Outputs 140a, 140b of the two players 16a, 16b are mixed and modified as desired for playback. The output 140 may be analog or digital.

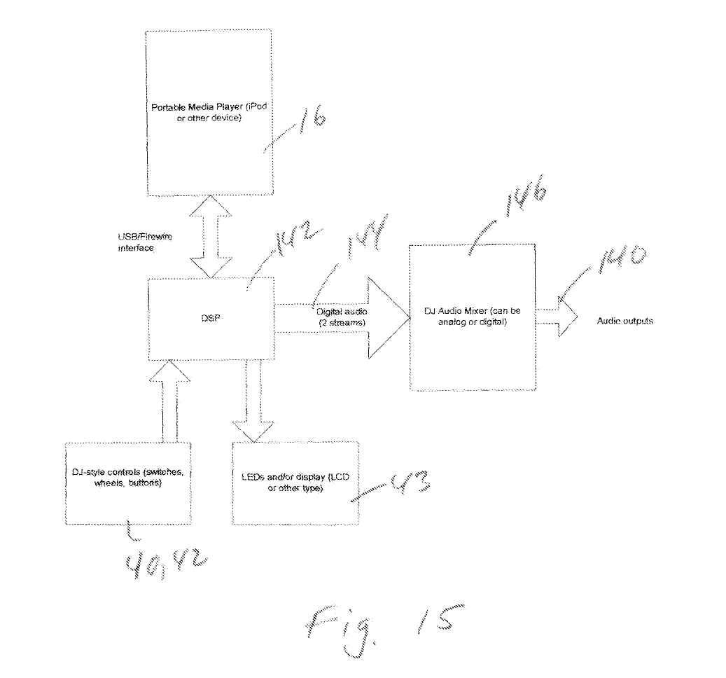

In FIG. 15, a further embodiment of the present invention is where the portable device 16 is shown as a mass storage device. In this embodiment, the operation system, menuing and controls of the portable media player 16 are not used. Instead, the portable media player 16 is merely employed and accessed as a storage device where the storage therein, such as a hard drive or RAM contains media items thereon. In this embodiment, the apparatus 10 includes its own operating system for control and command of the media items stored on the portable media player 16. The present invention for a portable media player 16 accessed as a mass storage device would be similar to attaching a portable media device 16, such as a portable external hard drive or memory unit.

In the embodiment of FIG. 15, disc jockey style controls 40, 42 access and command media files on the portable media player 16 acting as a mass storage device via digital signal processing (DSP) 144 control therebetween. The output 144 of the DSP is preferably in the form of multiple media streams which can be mixed at 146, modified and controlled, as above, for output 140 for performance playback.

In view of the foregoing, a new and novel docking system and mixer 10 for portable media devices is provided. It should be understood that the present invention preferably relates to a docking apparatus and mixer 10 for portable media players but it can also be used for any type of media device, including those that are portable. The present invention can be modified to accommodate any type of media player or device from any manufacturer. Furthermore, the present invention can be modified to not only mix and output audio but also video depending on the media device that is being accommodated by the present invention.

It would be appreciated by those skilled in the art that various changes and modifications can be made to the illustrated embodiments without departing from the spirit of the present invention. All such modifications and changes are intended to be covered by the appended claims.

What is claimed is:

1. A control interface for a portable media storage device, comprising:
a housing having a media controls thereon;
a microcontroller residing in the housing; the media controls being electrically interconnected to the microcontroller;
the portable media storage device having a media storage component therein with a first media item thereon; the media storage component being electrically interconnected to the microcontroller;
whereby manipulation of the media controls on the housing commands operation of the first media item;
an output connected to the portable media storage device; the output being controlled by the media controls on the housing.

2. The control interface of claim 1, wherein the portable media storage device is a portable media player.

3. The control interface of claim 1, wherein the housing further defines a seat; the portable media storage device being capable of residing in the seat.

4. The control interface of claim 1, further comprising:
an interface connector, connected to the microcontroller, which is connectable with an interface connector on the media storage device.

5. The control interface of claim 4, further comprising:
an interface connector, connected to the microcontroller and located in the seat, which is connectable to an interface connector on the media storage device.

6. The control interface of claim 2, wherein the media controls on the housing duplicate the functionality of controls on the portable media player.

7. The control interface of claim 1, wherein the media storage component is selected from the group consisting of a hard drive, solid state memory and removable storage media.

8. The control interface of claim 1, wherein the first media item is an audio file.

9. The control interface of claim 1, wherein the first media item is a video file.

10. The control interface of claim 1, wherein the media controls provide operation of play, stop, rewind, fast forward on the first media item.

11. The control interface of claim 1, wherein the media controls provide operation of volume control on the first media item.

12. The control interface of claim 1, further comprising:
means for commanding operation of a second media item residing on the media storage component.

13. The control interface of claim 12, wherein means for commanding operation of a second media item is a second array of media controls.

14. The control interface of claim 12, wherein playback of the first media item, providing a first output having a volume, and playback the second media item, providing a second output having a volume, is simultaneously executed from the media storage component of the media storage device.

15. The control interface of claim 14, further comprising:
means for mixing the first output and second output into a master output having a volume.

16. The control interface of claim 15, further comprising:
means for controlling the volume of the first output, the second output and the master output.

17. A control interface for a first portable media storage device and a second portable media storage device, comprising:
a housing having first media controls and second media controls thereon;
a microcontroller residing in the housing; the first media controls and the second media controls being electrically interconnected to the microcontroller;
the first portable media storage device having a first media storage component therein with at least one media item thereon; the first media storage component being electrically interconnected to the microcontroller;
the second portable media storage device having a second media storage component therein with at least one media item thereon; the second media storage component being electrically interconnected to the microcontroller;
whereby manipulation of the first media controls and second media controls on the housing respectively commands operation of the at least one media item on the first media storage component and the at least one media item on the second media storage component;
an output connected to the portable media storage device; the output being controlled by the media controls on the housing.

18. The control interface of claim 17, wherein the first portable media storage device and second portable media storage device is a portable media player.

19. The control interface of claim 17, wherein the housing further defines a first seat and a second seat; the first portable media storage device being capable of residing in the first seat and the second portable media storage device being capable of residing in the second seat.

20. The control interface of claim 17, further comprising:
a first interface connector and a second interface connector, which are connected to the microcontroller and respectively connectable with a first interface connector on the first media storage device and a second interface connector on the second media storage device.

21. The control interface of claim 20, further comprising:
a first interface connector and a second interface connector, which are connected to the microcontroller and located in the seat and respectively connectable with a first interface connector on the first media storage device and a second interface connector on the first second media storage device.

22. The control interface of claim 18, wherein the first media controls and the second media controls on the housing respectively duplicate the functionality of controls on the first portable media player and the second.

23. The control interface of claim 17, wherein the first media storage component and the second media storage component are selected from the group consisting of a hard drive, solid state memory and removable storage media.

24. The control interface of claim 17, wherein the at least one media item on the first media storage component and the at least one media component on the second media storage component is an audio file.

25. The control interface of claim 17, wherein the at least one media item on the first media storage component and the at least one media component on the second media storage component is a video file.

26. The control interface of claim 17, wherein the first media controls and the second media controls respectively provide operation of play, stop, rewind, fast forward on the at least one media item on the first media storage component and on the at least one media component on the second media storage component.

27. The control interface of claim 17, wherein the media controls provide operation of volume control on the at least one media item on the first media storage component and the at least one media component on the second media storage component.

28. The control interface of claim 17, further comprising:
a first output corresponding to playback of the at least one media item on the first media storage component;
a second output corresponding to playback of the at least one media component on the second media storage component.

29. The control interface of claim 28, further comprising:
means for mixing the first output and second output into a master output having a volume.

30. The control interface of claim 29, further comprising:
means for controlling the volume of the first output, the second output and the master output.
